(19) United States
(12) Patent Application Publication
(10) Pub. No.: US 2008/0189165 A1
(43) Pub. Date: Aug. 7, 2008

(54) METHOD AND SYSTEM FOR ESTIMATING ECONOMIC IMPACT OF PANDEMIC BASED ON INFRASTRUCTURE AVAILABILITY, WORKFORCE AVAILABILITY AND CONSUMPTION

(76) Inventors: Lianjun An, Yorktown Heights, NY (US); Young Min Lee, Old Westbury, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/670,535

(22) Filed: Feb. 2, 2007

(51) Int. Cl. G06Q 10/00

(52) U.S. Cl. 705/10

(57) ABSTRACT

A method and system estimating the gross output change in one or more industrial sectors is provided. Users are enabled to assess the impact of a pandemic on the demand market of a firm and to take proactive actions, for instance, shifting demand among industrial sectors, or among geographic regions. Economic impact is measured by gross output change in each industrial sector, as affected by workforce availability, infrastructure availability in each sector, and consumption change in each sector during the pandemic occurrence.

### BACKGROUND OF THE INVENTION

1. Field of the Invention

The present invention generally relates to estimating economic impact of pandemic based on infrastructure damage, workforce availability and consumption change. More particularly, the present invention estimates gross output change in different industrial sectors which result from the loss of balance in the corresponding microeconomic structure in the event of pandemic.

2. Background Description

There is a high likelihood that pandemic will occur in the not-too-distant future and that it will impact various aspects of society—creating death, despair, fear, and monetary cost, among other losses. Commercial enterprises will be negatively affected by a pandemic through loss of revenue, profit, employees and even a reduction in the value of the businesses themselves. Different industrial sectors will be affected to varying degrees in terms of the magnitude and dynamics of the impact of an epidemiological crisis.

One of the key factors impacting an overall economy, and firms within an economy, is the availability of technological infrastructure (an operational enviromnent) at times of epidemiological crisis. For instance, lack of electricity, highway and air transportation, water supply, Internet access, and so forth would hamper various aspects of business operations.

Another factor is availability of workforce. Some employees will not be available for work during and even after a pandemic for reasons such as the need to attend infectious family members, lack of infrastructure, fear, and perception of risk. Increased worker absenteeism would create workforce shortfalls hampering manufacturing, the delivery of goods, and the provision of services.

A further factor impacting the economy comprises change in consumer consumption, which represents economic demand.

Therefore, it is very useful for firms to be able to estimate the magnitude and dynamics of economic performance in various industrial sectors in the event of pandemic so that they can prepare for the situation and develop response plans. Prior art has described the epidemiological spread of pandemic with respect to time and geography using mathematical equations, for example, a system of differential equations. There is statistical evidence that previous pandemics have had significant economic effect. During the recent SARS occurrence, a comparatively short and limited pandemic with 775 deaths among 8097 infected, had a meaningful effect on economic and social activity.

There is also some microeconomic modeling that specifies constituents in an economy.

The prior art has not, however, used models and mathematical functions qualitatively to expose how constituents of an economy are affected under pandemic conditions and how a rebalance of demand and supply would affect the gross output in the different industrial sectors.

### SUMMARY OF THE INVENTION

To address the deficiencies of the prior art, the present invention estimates output changes for an industrial sector by using an epidemiological model of pandemic, as well as changes in infrastructure availability, workforce availability, and consumption. Changes in infrastructure availability, in workforce availability, and in consumption under pandemic conditions are applied to a microeconomic model that generates an estimated gross output change for an industrial sector. One available and potentially useful epidemiological model of pandemic is the SEIR (Susceptible, Exposed, Infectious and Recovered) model, which produces the information on population affected by pandemic such as susceptible, exposed, infectious and recovered population.

The present invention uses an epidemiological model of pandemic, including, but not limited to, SEIR to associate with some changes that result in economic consequence. The invention also uses information from a workforce availability model, which estimates dynamics of workforce availability resulting from employees being infected or having a perceived risk of being infected, and a need for attending family members during pandemic. The model also uses information of industrial infrastructure that supports business operation and changes due to absented maintaining and operating workforce.

The invention further models customer consumption that represents market demand and changes due to reduction of social activities. Then gross output change in different industrial sectors is estimated from re-balancing consumption change and supply in the microeconomic model.

Various industrial sectors include the following: media & entertainment, telecommunications, utilities, consumer products, retailer industry, travel & transportation, banks, financial markets, insurance, aerospace & defense, automotive, chemical & petroleum, electronics, industrial products, education, health, life sciences, government, computer services, global small medium biz etc.

The main objective of the present invention is to quantify economic environment change under a pandemic. Specifically, the economic environment change in different industrial sectors is quantified. This invention can be used to assist a firm in assessing the impact of a market change on its business. A firm matching its target markets to appropriate industrial sectors can use the model to estimate demand change for its product and services and establish a strategic plan for responding to changes in the event of a pandemic.

The present invention thus provides a computer-implemented method, a system to estimate economic environment change by applying mathematical calculation in the casual influence network and feedback loops captured in the model.

A method or system for estimating change in economic constituent may therefore comprise one or more of:
a. Estimating infectious population using epidemiological model of pandemic spread.
b. Estimating workforce availability using the behavior model.
c. Inputting sensitivity parameters related to likelihood of basic infrastructure (electricity, water, internet, air and ground transportation) breakdown and workforce needed to maintain and operate the corresponding infrastructure.
d. Inputting sensitivity parameters related to infrastructure dependence on some natural resources that are likely damaged by disease virus (like water supply).
e. Inputting parameters describing government policies, like airport and road closings that affect air and ground transportation.
f. Estimating infrastructure specific to each industrial sector change in a similar way for the basic infrastructure due to their coherence to the basic infrastructure.
g. Inputting sensitivity parameter related to likelihood to reduce social activities and sensitivity parameter for medical supply request related to infected population.
h. Inputting disposable income as a portion of household income and coming from the microeconomic model.
i. Estimating consumption change in each industrial sector related to pandemic.
j. Estimating production rate in each industrial sector based on workforce availability, infrastructure availability, consumption change and investment.
k. Estimating gross output change in each industrial sector and gross domestic product (GDP) change as the sum of gross output in all industrial sectors.

According to the present invention, the overall GDP changes due to production rate change in all industrial sectors. Production rate changes due to demand shifting among multiple industrial sectors and overall workforce reduction and infrastructure damage in some industrial sectors.

The present invention thus provides a system and a method for estimating changes of gross output in various industrial sectors. The method of the present invention may be set forth in machine-readable instructions enabling a computer or other data processing apparatus to implement the method of the present invention, which comprises the steps of: using a computer to access an epidemiological model of pandemic to determine the size of a population infected; using a computer to quantify change in workforce as a result of pandemic occurrence; using a computer to quantify change in infrastructure within an industrial sector as a result of pandemic occurrence; using a computer to quantify change in consumption within an industrial sector as a result of pandemic occurrence; using a computer to compute production rate change based on the change in workforce, infrastructure and consumption and to correlate these changes with a microeconomic model; and using a computer to provide said production rate change as output.

Change in workforce availability may be computed by accessing a workforce availability behavior model. Change in infrastructure availability may be computed using a determination of one or more of likelihood of breakdown, sensitivity to workforce availability, and correlation to natural resources and utility supply. Change in consumption may be computed by determining one or more of change in one or more social activity patterns, change attributable to one or more special medical needs, and change in disposable household income.

Production rate change may be computed based on change in demand, while change in demand may be determined on the basis of change in consumption. Production rate change may also be computed based on changes in supply, while change in supply is determined on the basis of one or more of change in workforce availability and change in infrastructure availability.

Gross output is computed for one or more of the following industrial sectors: media, entertainment, telecommunications, utilities, consumer products, retail industry, travel, transportation, banking, financial markets, insurance, aerospace, defense, automotive, chemicals, petroleum, electronics, industrial products, education, health, life science, government, computer service, small business, and mid-size business.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an overview for estimating economic environment change according to the present invention.

FIG. 2 shows an overview of causal relationships according to the present invention.

FIG. 3 shows a detail of causal relationships according to the present invention.

FIG. 4 shows sample gross output change from the model under milder pandemic according to the present invention.

FIG. 5 shows sample gross output change from the model under severe pandemic according to the present invention.

### DETAILED DESCRIPTION OF THE PREFERRED EMBODIMENTS OF THE INVENTION

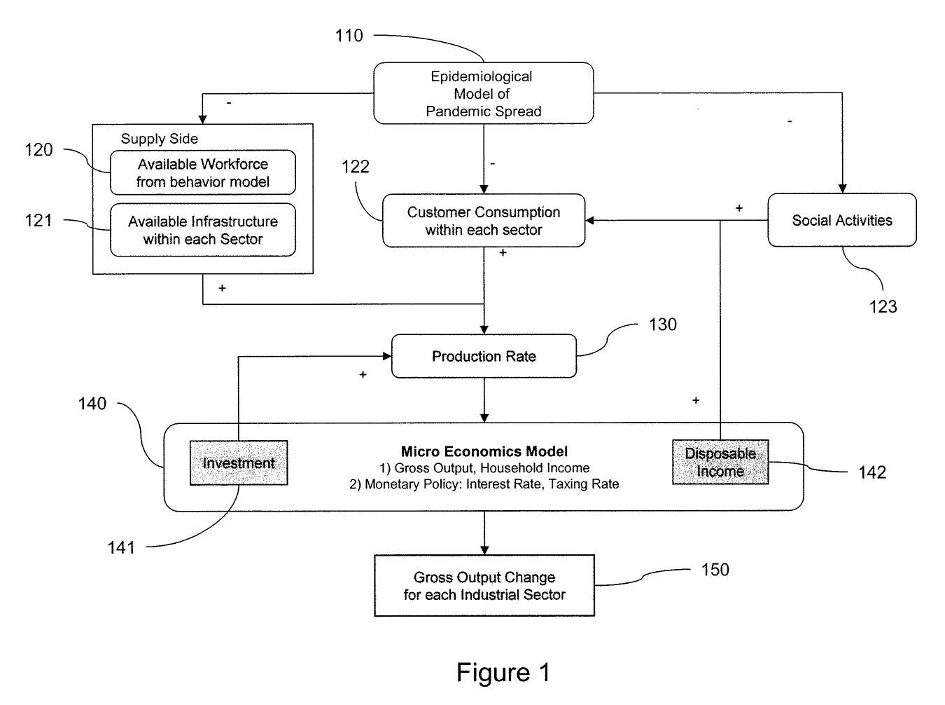

Referring now to the drawings, and more particularly to FIG. 1, there is shown an overview for estimating workforce absenteeism according to the present invention. An epidemiological model of pandemic for an infectious population 110 is accessed, which may be done using a computer connected to system on which the model or database of modeling results is stored. Available workforce change in each county and each country along timeline is then estimated by accessing workforce behavior model 120.

Similarly, the infrastructure model gathers sensitivity data specified for each region, infectious status from 110 and workforce availability from 120 as well as air and road closing government policies and estimates infrastructure availability for each industrial sector 121. Both workforce and infrastructure availabilities represent supply side change under pandemic in our economic environment.

The present invention models that social activities are reduced significantly and different sectors would be affected differently based on its nature of business as well as scope of the sector. Reduction (increasing) factors are estimated for each sector 123. Consumption change in each sector is estimated based on both infectious status from 110 and the reduction factors from 123 as well as disposal income 142 from the micro economic model 140.

The production rate for each sector 130 is calculated from the changes in supply side (workforce and infrastructure availability 120 and 121), changes in investment 140 from the micro economic model 141 and changes in demand side (consumption 122). The micro economic model 140 takes production rate 130 as an input and feedbacks through disposable income and investment to consumption and production and estimates gross output change for each industrial sector 150.

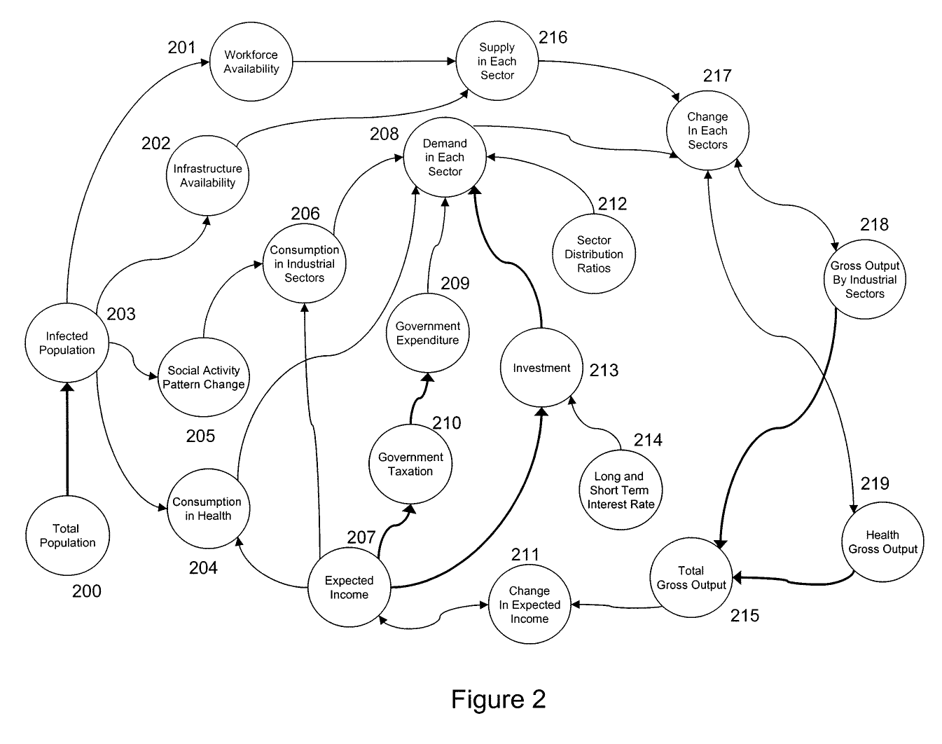

FIG. 2 shows an overview of causal relationships according to the present intention. The infectious percentage, infectious population 203 divided by the total population 200, is used to estimate the workforce availability 201, infrastructure availability 202 and social activity pattern change 205. The customer consumption in each industrial sector 206 is influenced by social activity pattern change 205. The consumption on health sector 204 is shown separately due to its unique position in the pandemic case and will increase proportional to the infected population 203. Supply in each industrial sector 216 is determined by available workforce 201 and infrastructure 202. Demand in each industrial sector 208 consists of consumption change 206, government expenditure 209 and investment 213. Demand ultimately depends on expected household income 207 and government expenditure 209 is supported through taxation 210 from household income 207. Production change in each industrial sector 217 is determined by demand 208 and supply 216 as well as current gross output level 218. The total gross output 215 (GDP) is the sum of all industrial sector gross outputs 218 including health 219. The change in expected income 211 would be determined based on balance between total gross output 215 and the current expected household income 207. Note that some arrows with both directions indicate mutual dependence of variables. And economic environment changes simultaneously with other factors in the system.

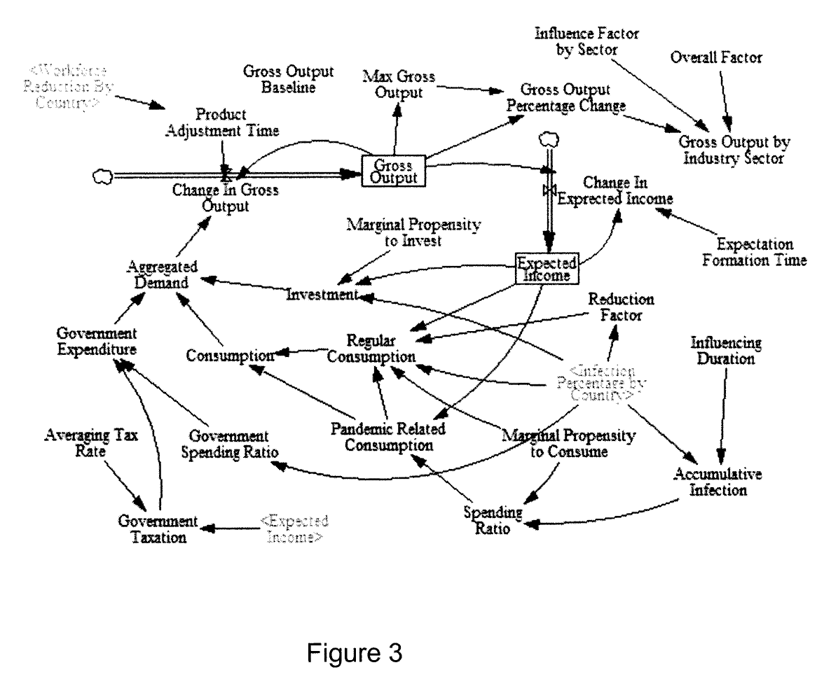

FIG. 3 shows some dependencies among factors and dynamical influence in economic model in terms of the stock flow diagram in which mathematical formulation can be specified. In particular, the following equations show mathematically dynamical dependence of other factors. The change of available infrastructure is influenced by the maintenance and operation workforce, natural resource and utilities (electricity, internet, air and road transportation) availability. The change of customer consumption is influenced by social activity pattern change, the medical related cost and disposable income. Then production and unemployment rate will change accordingly due the changes of the above factors and affect gross output.

$$\begin{matrix}I = {f}_{inf} ( M , O , N , U ) & ( Equation 1 ) \\ C = {f}_{con} ( S , E , D ) & ( Equation 2 ) \\ \frac{d G}{d t} = \frac{( V + C - G ) * I * W}{T} & ( Equation 3 )\end{matrix}$$

where

I. Infrastructure availability

ƒ_{inf}: Function for infrastructure

M. Effect of maintenance workforce reduction

O: Effect on operating workforce reduction

N: Effect of natural resource damage

U: Utility supply unavailability effect

C: Customer consumption

ƒ_{con}: Function for consumption

S: Effect of social activity reduction

E: Effect of medical need increase

D: Disposable income (from the micro economic model)

G: Gross output

V: Investment (from the micro economic model)

W: Available workforce (from the behavior model)

T: Time need to affect production

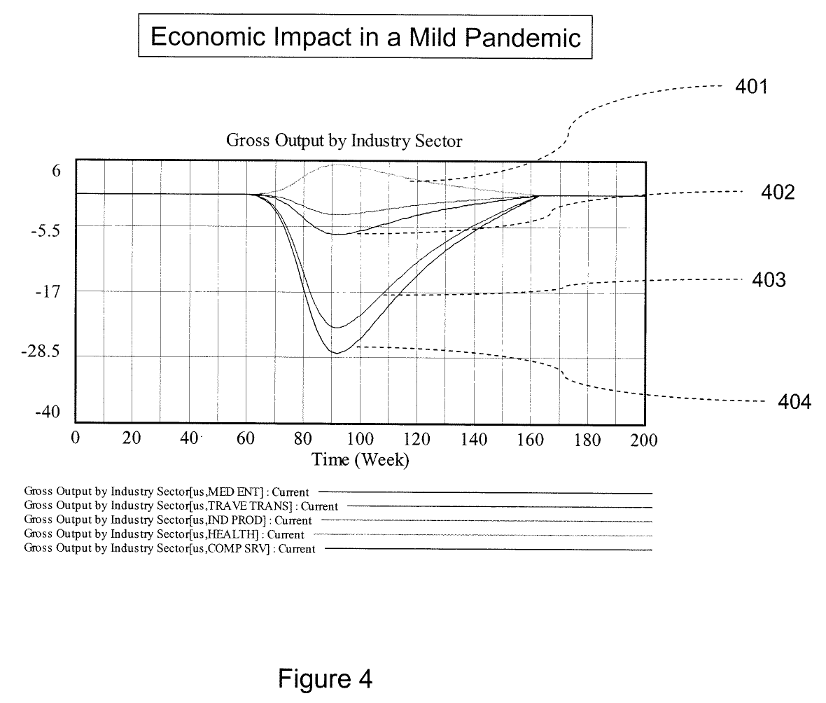

FIG. 4 shows sample output from the model according to the present invention in a mild pandemic. The line 401 indicates a gross output increase in heath industrial sector. The line 402 indicates a gross output decrease in the computer service industrial sector. The line 403 indicates a gross output decrease in travel and transportation industries. The line 404 indicates a gross output decrease in media and entertainment industries. The overall GDP drops 2% and recovers after a short period.

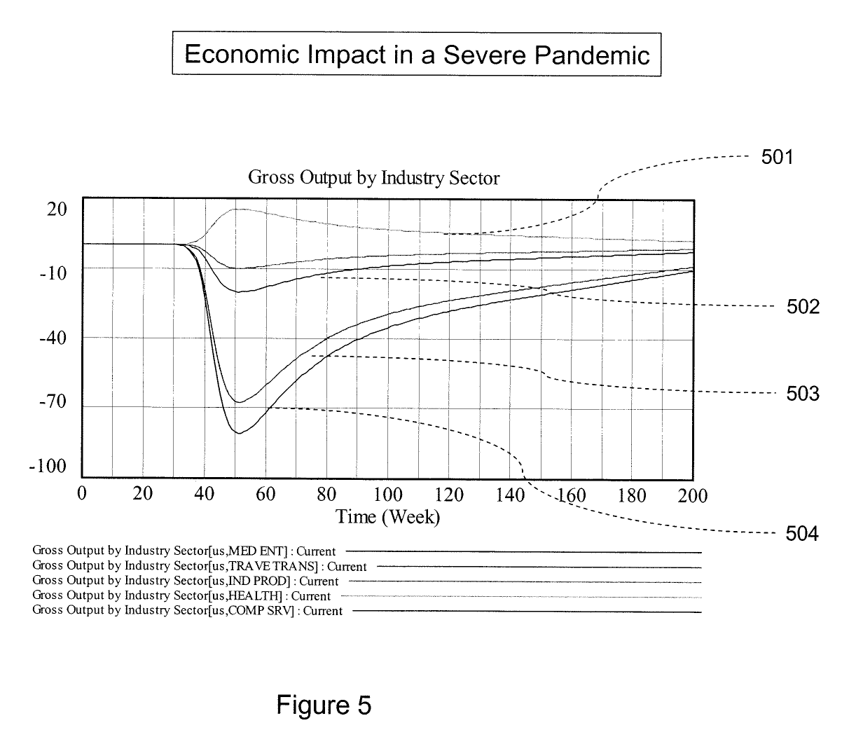

FIG. 5 shows sample output from the model according to the present invention in a severe pandemic. The line 501 indicates a gross output increase in heath industrial sector. The line 502 indicates a gross output decrease in the computer service industrial sector. The line 503 indicates a gross output decrease in travel and transportation industries. The line 504 indicates a gross output decrease in media and entertainment industries. The overall GDP drops 5% and recovers after a longer period.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A method for estimating changes of gross output in various industrial sectors comprising the steps of:
using a computer to access an epidemiological model of pandemic to determine the size of a population infected;
using a computer to quantify change in workforce as a result of pandemic occurrence;
using a computer to quantify change in infrastructure within an industrial sector as a result of pandemic occurrence;
using a computer to quantify change in consumption within an industrial sector as a result of pandemic occurrence;
using a computer to compute production rate change based on the change in workforce, infrastructure and consumption and to correlate these changes with a microeconomic model; and
using a computer to provide said production rate change as output.

2. The method of claim 1, wherein change in workforce availability within an industrial sector is computed by accessing a workforce availability behavior model.

3. The method of claim 1, wherein change in infrastructure availability within an industrial sector is computed using a determination of one or more of
likelihood of breakdown,
sensitivity to workforce availability, and
correlation to natural resource and utility supply.

4. The method of claim 1, wherein said change in consumption within an industrial sector as a result of pandemic occurrence is computed by determining one or more of
change under conditions of a pandemic in one or more social activity patterns,
change under conditions of a pandemic attributable to one or more special medical needs, and
change under conditions of a pandemic in disposable household income.

5. The method of claim 1, wherein said production rate change in each industrial sector is computed based on changes in demand.

6. The method of claim 5, wherein said change in demand is determined on the basis of change in consumption.

7. The method of claim 1, wherein said production rate change in each industrial sector is computed based on changes in supply.

8. The method of claim 7, wherein said change in supply is determined on the basis of one or more of change in workforce availability and change in infrastructure availability.

9. The method of claim 1, wherein gross output is computed for one or more of the following industrial sectors:
media,
entertainment,
telecommunications,
utilities,
consumer products,
retail industry,
travel,
transportation,
banking,
financial markets,
insurance,
aerospace,
defense,
automotive,
chemicals
petroleum,
electronics,
industrial products,
education,
health,life science,
government,
computer service,
small business, and
mid-size business.

10. A system for estimating changes of gross output in various industrial sectors comprising:
a computer accessing an epidemiological model of pandemic to determine the size of a population infected;
a computer quantifying change in workforce as a result of pandemic occurrence;
a computer quantifying change in infrastructure within an industrial sector as a result of pandemic occurrence;
a computer quantifying change in consumption within an industrial sector as a result of pandemic occurrence;
a computer computing production rate change based on the change in workforce, infrastructure and consumption and to correlate these changes with a microeconomic model; and
a computer providing said production rate change as output.

11. The system of claim 10, wherein change in workforce availability is computed by accessing a workforce availability behavior model.

12. The system of claim 10, wherein change in infrastructure availability is computed using a determination of one or more of
likelihood of breakdown,
sensitivity to workforce availability, and
correlation to natural resource availability and utility supply.

13. The system of claim 10, wherein said change in consumption is computed by determining one or more of
change under conditions of a pandemic in one or more social activity patterns,
change under conditions of a pandemic attributable to one or more special medical needs, and
change under conditions of a pandemic in disposable household income.

14. The system of claim 10, wherein said production rate change is computed based on change in demand.

15. The system of claim 14, wherein said change in demand is determined on the basis of change in consumption.

16. The system of claim 10, wherein said production rate change is computed based on change in supply.

17. The system of claim 16, wherein said change in supply is determined on the basis of one or more of change in workforce availability and change in infrastructure availability.

18. The system of claim 10, wherein gross output is computed for one or more of the following industrial sectors:
media,
entertainment,
telecommunications,
utilities,
consumer products,
retail industry,
travel,
transportation,
banking,
financial markets,
insurance,
aerospace,
defense,
automotive,
chemicals
petroleum,
electronics,
industrial products,
education,
health,life science,
government,
computer service,
small business, and
mid-size business.

19. A machine-readable medium for estimating changes of gross output in various industrial sectors on which are provided:
machine-readable instructions for using a computer to access an epidemiological model of pandemic to determine the size of a population infected;
machine-readable instructions for using a computer to quantify change in workforce as a result of pandemic occurrence;
machine-readable instructions for using a computer to quantify change in infrastructure within an industrial sector as a result of pandemic occurrence;
machine-readable instructions for using a computer to quantify change in consumption within an industrial sector as a result of pandemic occurrence;
machine-readable instructions for using a computer to compute production rate change based on the change in workforce, infrastructure and consumption and to correlate these changes with a microeconomic model; and
machine-readable instructions for using a computer to provide said production rate change as output.
